(19) United States
(12) Patent Application Publication
(10) Pub. No.: US 2007/0198397 A1
(43) Pub. Date: Aug. 23, 2007

(54) Electronic Trading System

(75) Inventors: John MCGINLEY, London (GB); Ian GREAVES, London (GB)

Correspondence Address: TAYLOR RUSSELL & RUSSELL, P.C., 4807 SPICEWOOD SPRINGS ROAD, BUILDING TWO SUITE 250, AUSTIN, TX, 78759, US

(73) Assignee: PATSYSTEMS (UK) LTD, London (GB)

(21) Appl. No.: 11/467,227

(22) Filed: Aug. 25, 2006

(30) Foreign Application Priority Data
Feb. 25, 2004 (GB) 0404143.0

(51) Int. Cl. G06Q 40/00

(52) U.S. Cl. 705/37

(57) ABSTRACT

An electronic trading system is disclosed for principally for trading in intangible things, particularly financial instruments. The trading system comprising a quality-of-service (QoS) subsystem, which subsystem is operative to impose limitations upon trading activities in order that the performance of a component of the system or of the system as a while is maintained within specified tolerances. For example, it may limit the number of events that can be initiated by a trader. It may also allow some messages to be routed through the system with a priority that is higher than others when such messages have a particular content (e.g. are inherently urgent in nature or essential to proper operation of the system) or are to or from a privileged user. The system also has an integrated protocol stack for routing of data to enable the location of data bottlenecks to be identified.

This invention relates to an electronic trading system. It has a particular application to a system for trading in intangible things, such as financial instruments. However, it might also find application in trading in anything that might be traded in an electronic market.

Providing a trader with an effective interface to an electronic market provides a considerable technical challenge. To be effective, the trader must be presented with accurate and timely information relating to the state of the market, and the trader must be able to buy and sell within the market at a known price. The complexity of the entire system is considerably increased by the fact that there are a variable number of traders active at any one time, and that it is not possible to predict accurately when any one of them may initiate a trading request.

In addition to straightforward performance in processing of transactions, it is also of great importance that the performance is maintained within well-defined limits. That can be expressed as a guaranteed quality of service (QoS).

The ultimate performance of the trading system may depend upon the hardware upon which its software is executing and upon fixed infrastructure, such as telecommunication links, that cannot economically be upgraded to cope with the maximum anticipated system load. Therefore, an aim of this invention is to provide a trading system that can offer a required QoS to a trader interacting with an electronic market despite such constraints.

From a first aspect, this invention provides a trading system comprising a quality-of-service (QoS) subsystem, which subsystem is operative to impose limitations upon trading activities in order that the performance of the system as a whole is maintained within specified tolerances.

Very generally, the QoS imposes limitations upon specific activities to preserve the overall well-being of the system. It ensures that users are not permitted to make demands upon the system that go beyond the capacity of the platforms on which it is implemented. This is in contrast to the more traditional approach of detecting when the system becomes overloaded and then reacting to remedy the situation.

As a first example of its function, the QoS subsystem may impose a limit upon the rate at which data can enter the system. For example, it may limit the number of requests that will be accepted on an input. More specifically, it may control the number of requests that can be made in a time slice. Within that time slice, a limit may alternatively or additionally be placed on the size of burst data that may be received into the system.

Suitably, the token bucket algorithm may be used in order to limit the flow of requests into the system (although this is just one of many possible algorithms). This algorithm is commonly used in computer networking to control the flow of data packets in a network and can limit throughput in a moving timeslice rather than in fixed, periodic time slots. However, the advantages that it provides are not generally recognised by those skilled in the technology of this invention.

Where operating regulations allow, it may be advantageous to provide a level of service that is dependent upon the identity of a user from which a service originates or to whom it is directed. Thus, the system may, at any time, allow a request to enter the system conditionally upon the source or destination of the request. It may also be dependent upon the nature of the service. Thus, rules may be formulated that allow available resources to be applied to tasks that are considered to be most important.

An important aspect to the control of QoS is control of all aspects of data transport within the system. Therefore, it is particularly advantageous that a single integrated metric stack handles all data transportation within the system from the business level down to the hardware level.

A further preferred feature of the QoS subsystem is an ability for the system to measure its performance and dynamically reconfigure itself based on these measurements to ensure a defined level of quality-of-service. For example, the system may provide the ability to intelligently shed load based on business priority, intelligently delay updates, operate in a distributed manner (requiring no centralised point of control) and limit bandwidth consumption to a predefined maximum at a business defined application level. This is in contrast to the simpler concept of limiting load at a network level.

A trading system embodying the invention may incorporate priority-based routing. That is to say, the QoS subsystem may be operative to assign a priority to a message, messages with a high priority being handled in preference to those with a low priority. The priority may be determined in accordance with pre-defined rules. The rules may apply a priority to a message based on one or more of the sender of the message, the recipient of the message or the content of the message. For example, the priority may be a numerical value that is calculated by addition of contributed values derived from the message.

The QoS subsystem may be operative to control latency and accuracy of communication of data from the trading system to external client applications. For instance, the client application may request that the data is sent as fast as possible or that data batching be applied. In effect, a client can connect and request that the system batch data (high latency) but that all changes must be sent, or the client could request that a low-latency link be established and that only the latest data is required. Moreover, the client application may request that all data changes during a period are to be reported or that only the latest data be reported.

Conveniently, the QoS subsystem may monitor performance of the application by way of Java Management Extensions.

More generally, a trading system embodying the invention may use a rule-based system to control alarm reporting, fault diagnosis and reconfiguration. This provides for a great amount of flexibility in configuration of the system.

From a second aspect, the invention provides a computer software product executable upon a computer hardware platform to perform as a trading system according to the first aspect of the invention.

From a third aspect, the invention provides a server in a network of trading computers comprising a computer hardware platform executing a computer software product according to the second aspect of the invention.

From a further aspect, the invention provides a method of operating a trading system that comprises a quality-of-service (QoS) subsystem, which subsystem imposes limitations upon trading activities in order that the performance of a component of the system or of the system as a whole is maintained within specified tolerances.

An embodiment of the invention will now be described in detail, by way of example, and with reference to the accompanying drawings, in which:

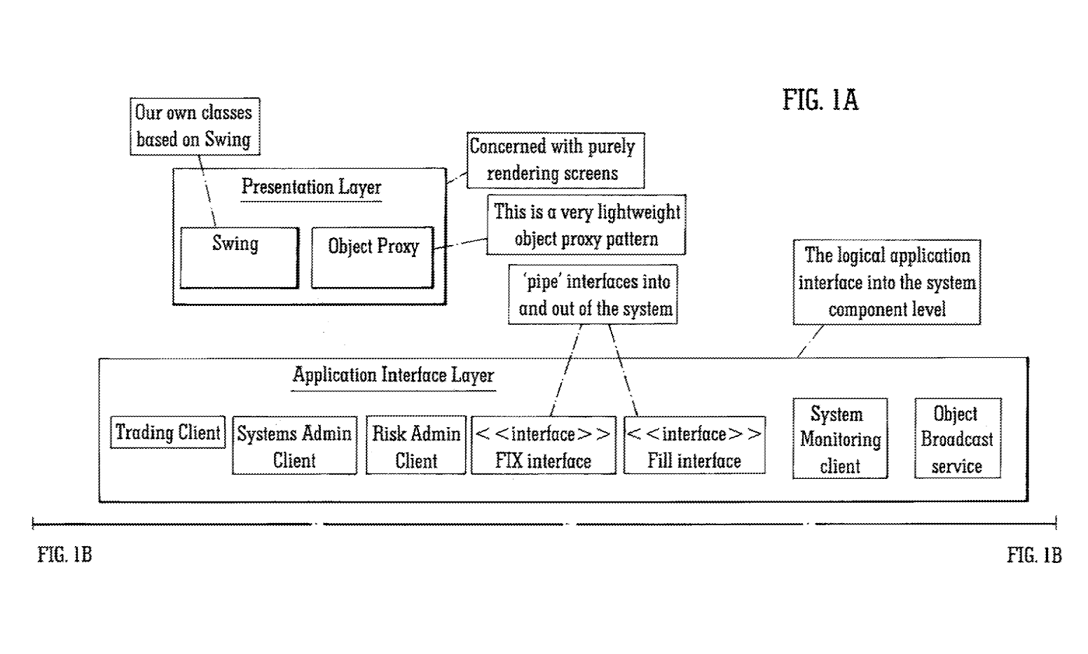

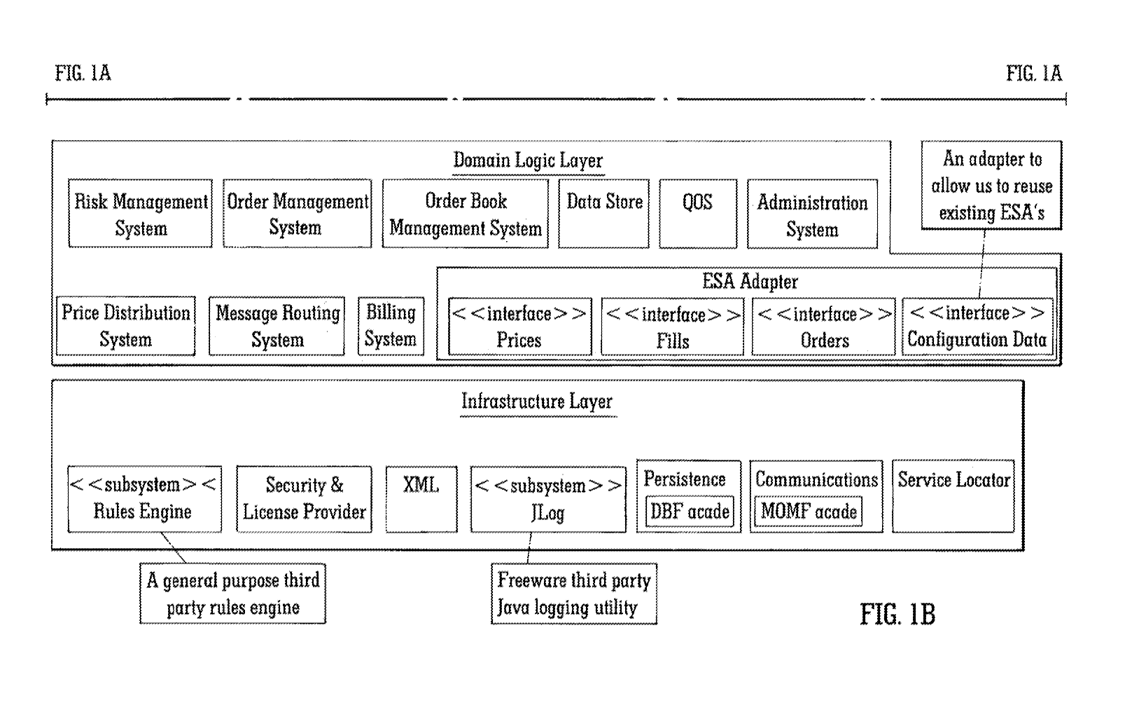

FIG. 1 is a diagram showing the principal logical layout of a system embodying the invention;

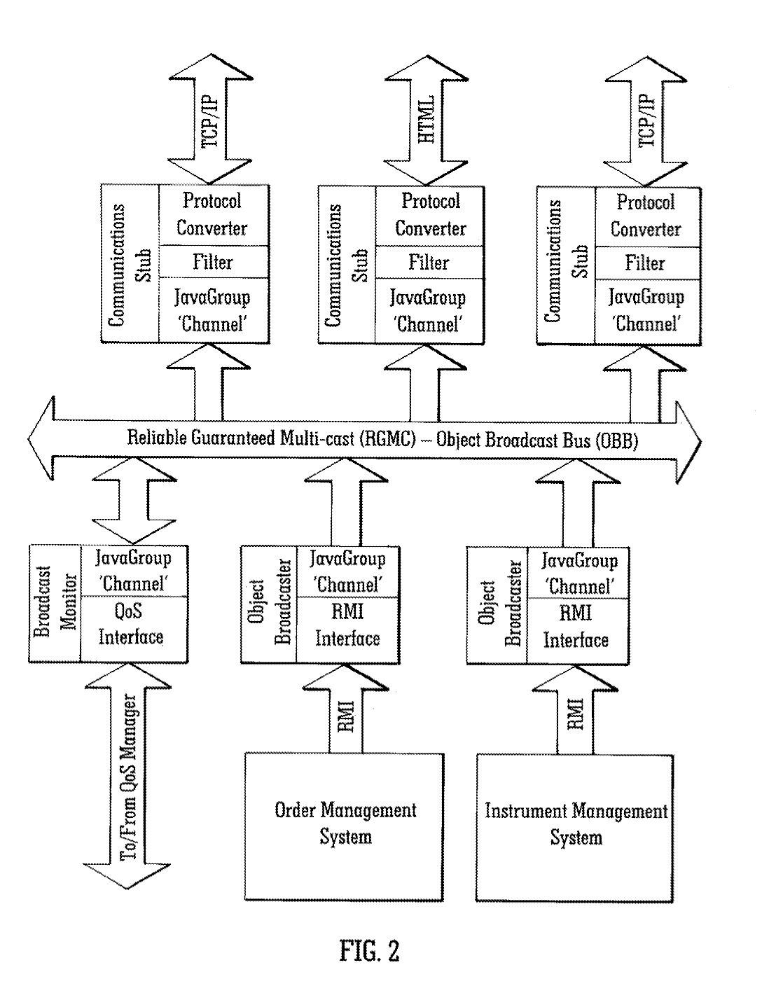

FIG. 2 is a diagram showing the object broadcast bus, being a component of the embodiment of FIG. 1, and its link to the QoS subsystem;

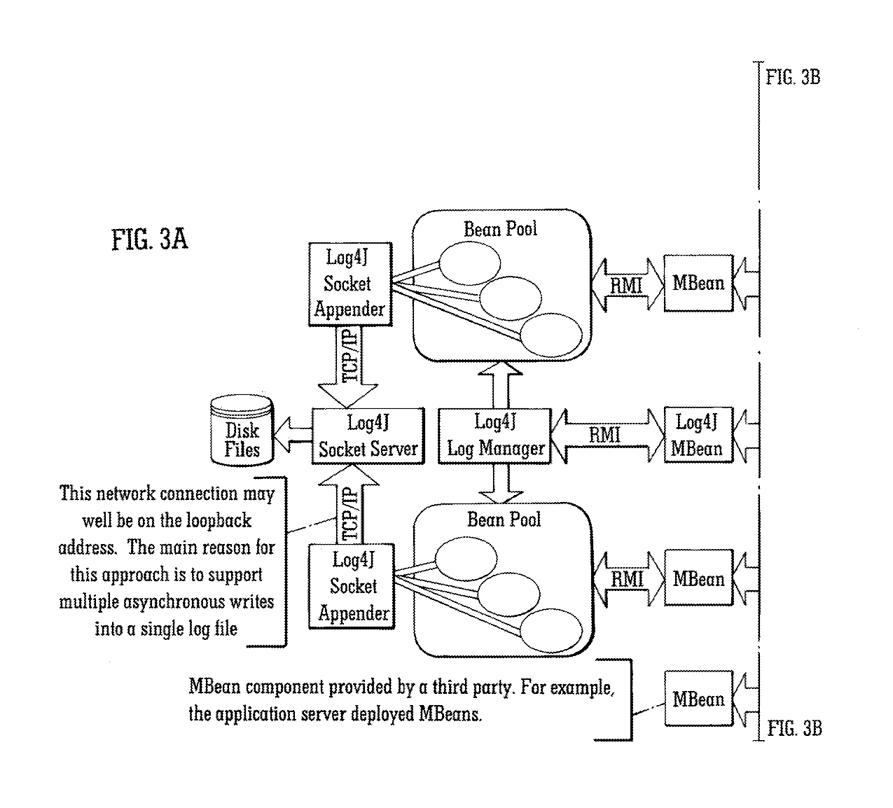

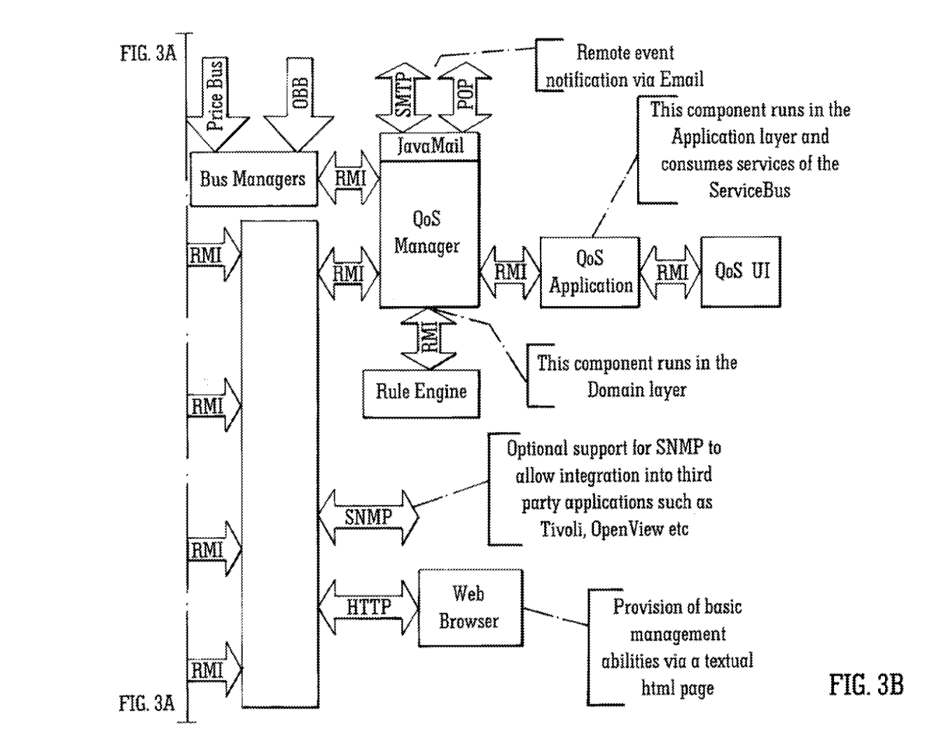

FIG. 3 is a diagram that illustrates the design of this QoS module of the embodiment of FIG. 1;

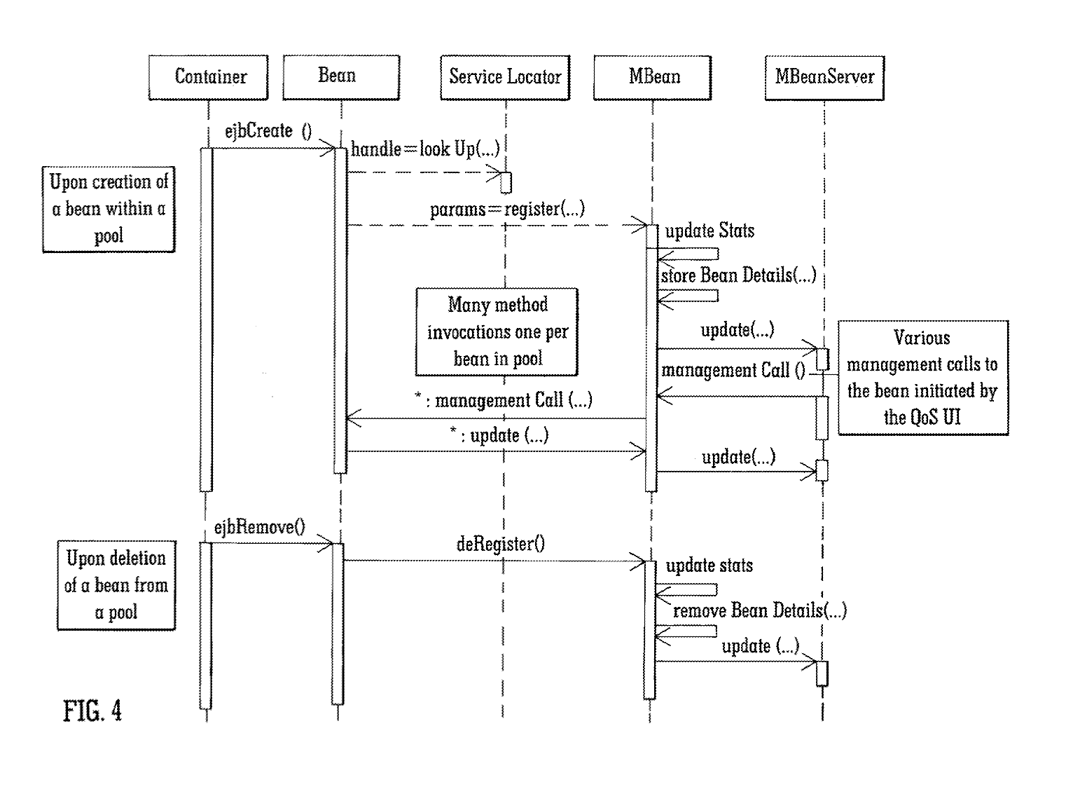

FIG. 4 is a diagram that illustrates interactions between the MBeans and bean pools in the QoS subsystem;

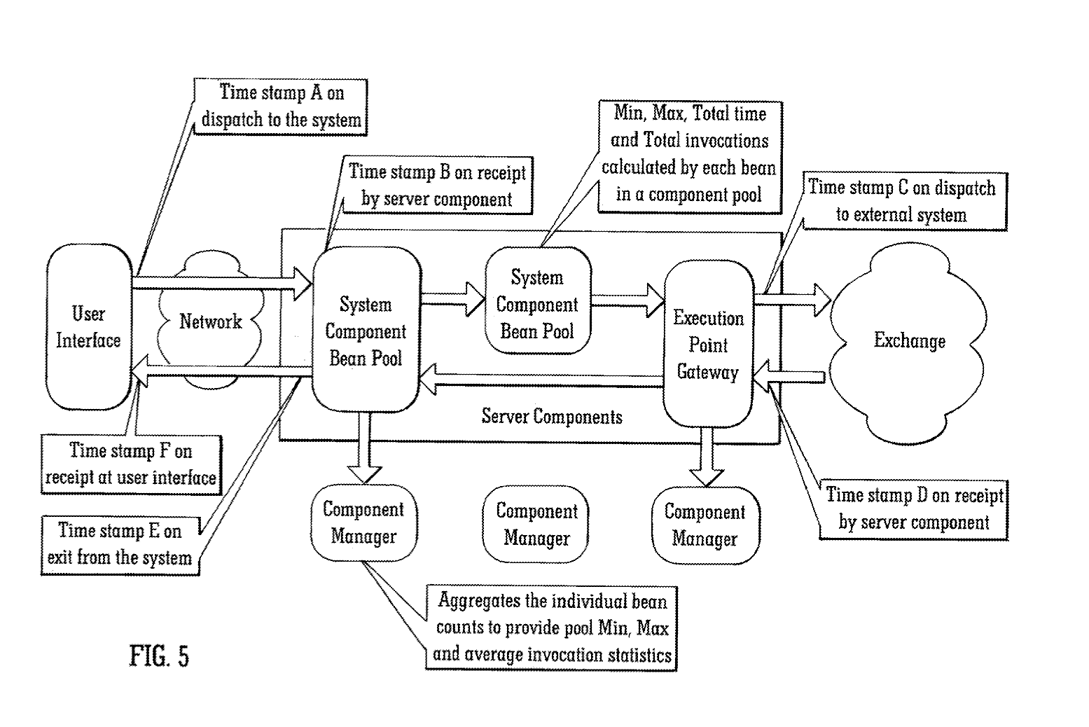

FIG. 5 illustrates various parameters measured by the QoS subsystem in the embodiment of FIG. 1;

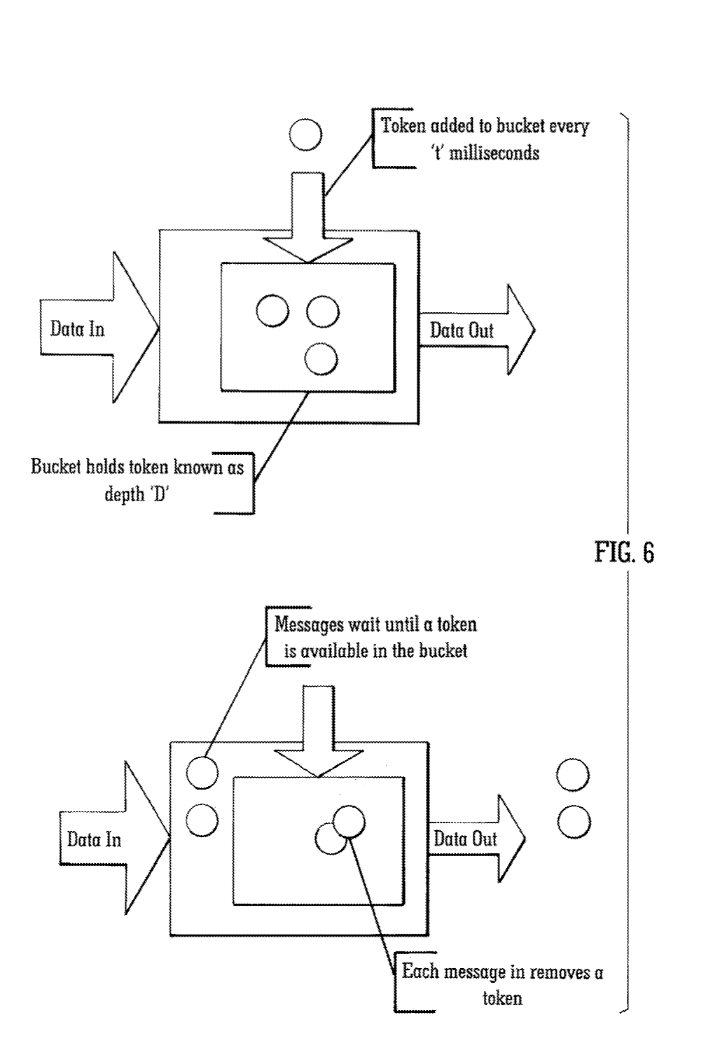

FIG. 6 illustrates monitoring of response time of objects within the embodiment;

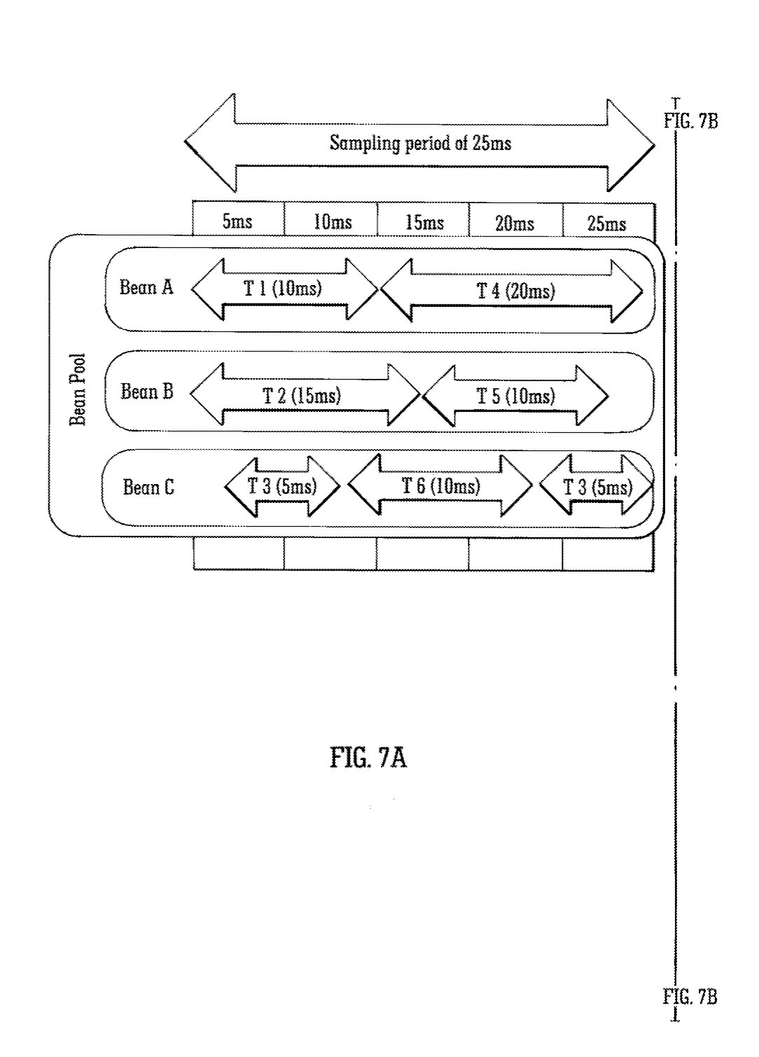

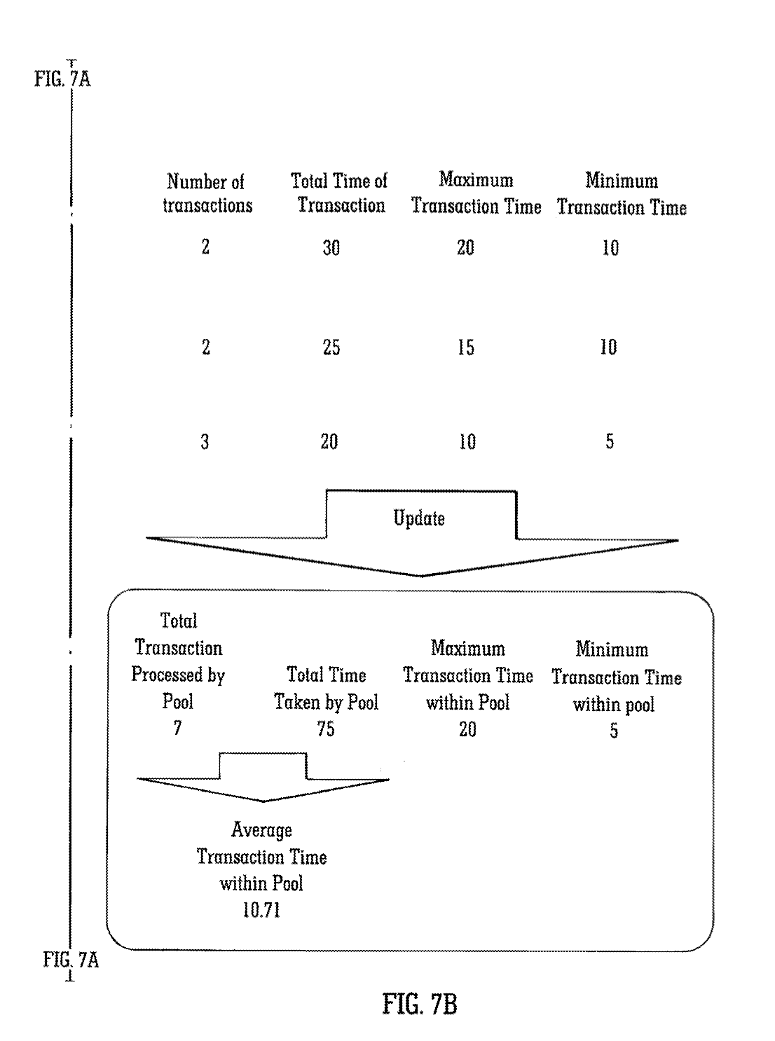

FIG. 7 illustrates the operation of request bandwidth control;

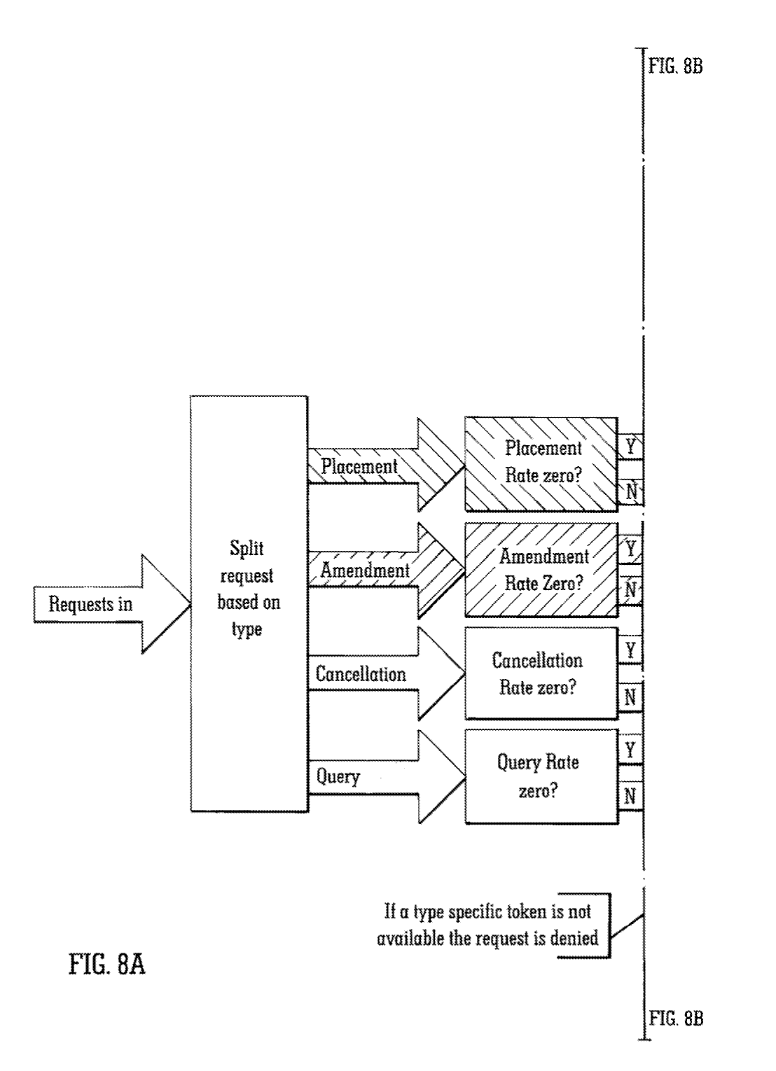

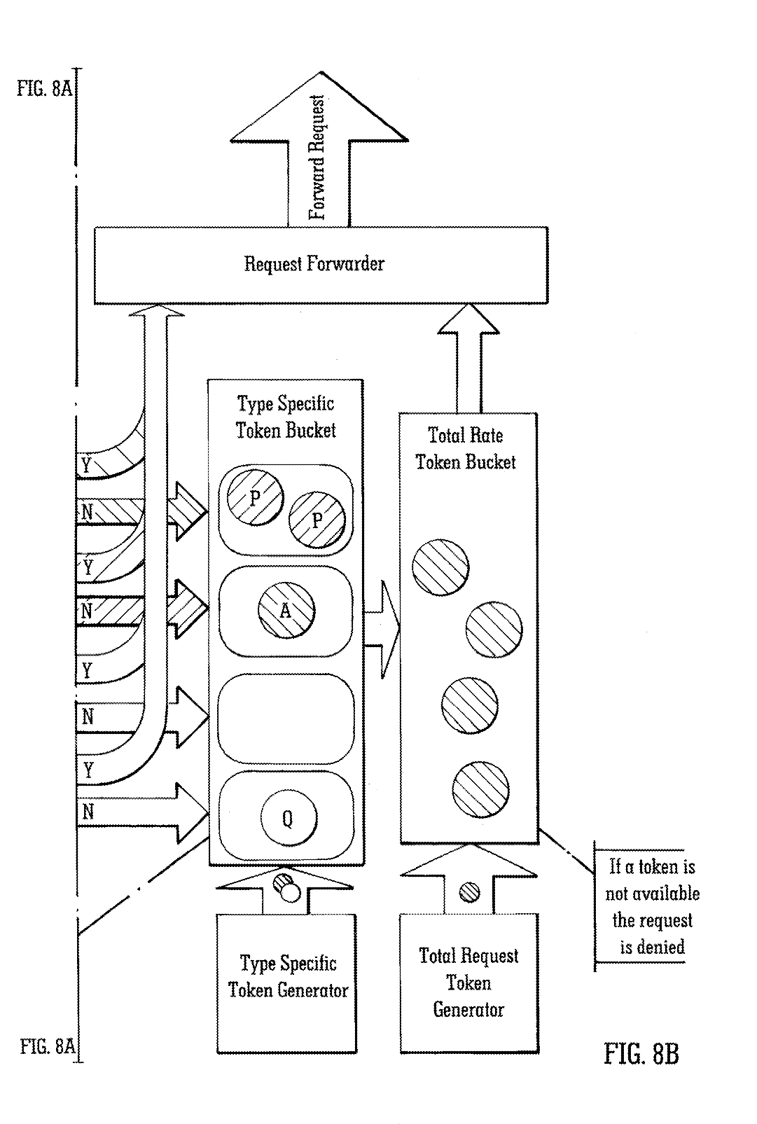

FIG. 8 is a diagram illustrating operation of the “token bucket” algorithm; and

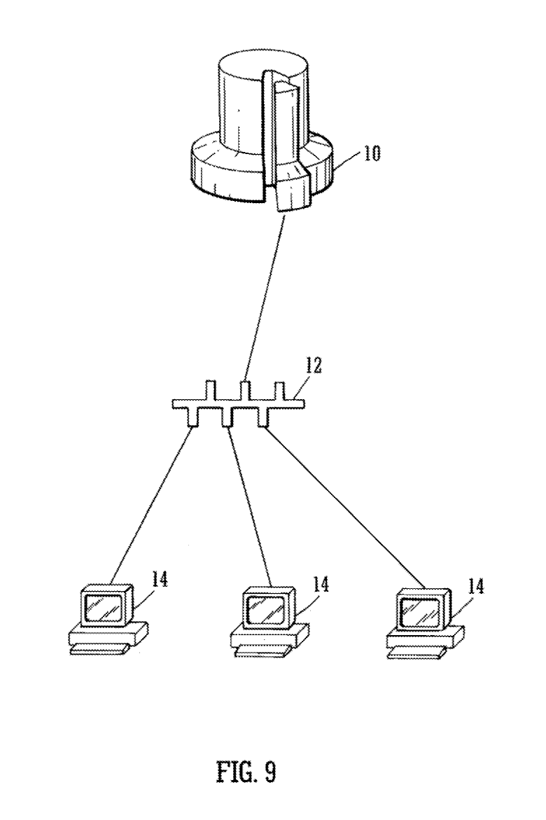

FIG. 9 illustrates a system embodying the invention participating as a server in a group of networked computers.

The invention will be described in the context of an electronic trading platform. The overall system is based on the ‘layer’ pattern. FIG. 1 presents the high-level logical view of the system. Note not all packages are displayed; only those that show significant architectural concepts. Moreover, many of the packages are not of direct relevance to the invention and are described only to the extent required to place the description of the invention in context.

This embodiment is implemented using the Java language, and it is assumed that the skilled person to whom this description is addressed is familiar with Java and associated technologies. However, it will be understood that a Java implementation is merely a preference and is not essential to the invention.

The Layers

The following sections detail the role of the components within the system, and the interaction between the layers of the system.

Infrastructure Layer

The infrastructure layer provides the basic functionality required for the system such as; persistent data storage, a standard interface for access to asynchronous messaging, a system wide accessible mechanism for event logging, a system wide mechanism for rule processing, a centralized system for security and access control and a system wide service location facility.

Domain Layer

The domain layer provides a set of shared resources for executing the business processes of the system such as order entry, price distribution, contract (instrument) management and message routing. This layer should be thought of as providing a set of ‘services’ that can be consumed by the application layer. In this respect the architecture is similar to the ‘service oriented architecture’ employed in the web services field. The following diagram shows how interfaces are exposed from the domain logic layer and aggregated by the application layer to provide different applications via the use of a ‘virtual’ service bus.

Application Interface Layer

The application interface layer acts as an aggregation of services provided by the domain layer and provides the distribution protocol for inter/intra-net connectivity. The packages in this layer aggregate services provided by the domain layer into the applications that are required.

Presentation Layer

The presentation layer handles how the screen rendering is conducted. It contains the minimum logic required to achieve this goal. It contains a screen rendering package, a lightweight object proxy implementation and a communications library package.

The Packages

This section provides a brief overview of the responsibilities of each of the packages within the system. This is only intended to give a brief overview of what a package does and is not a comprehensive description of the responsibilities of each package.

Swing

This package is concerned with providing the graphical components required for screen rendering for the entire system. It is based on the Java Swing classes.

Object Proxy

This package is a very thin object proxy implementation simply to support the client side access to the concrete objects within the application interface layer.

Communications Package

This package contains the code required for intranet and Internet communications. This package is deployed both in the application layer and the presentation layer. It supports the use of TCP/IP (via SSL/TLS), serialized objects over HTTP(S) and XML over HTTP(S).

Trading Client (TC)

The TC is responsible for aggregating the functionality required for a user interactive trading application and providing the statefull session management of this connection. The services for submitting, amending, cancelling orders and receiving prices are aggregated together to provide the trading application.

Systems Administration Client (SAC)

The SAC is used to configure the standing data in the system such as contracts, user accounts, order routes etc. The services such as contract configuration, editing user accounts and setting passwords are aggregated to provide the system administration application.

Risk Administration Client (RAC)

The RAC application provides the pre-trade risk permissioning and the post-trade risk monitoring within the system. The services for editing account limits, monitoring risk parameters and editing risk system rules are aggregated to provide the risk management system.

Financial Information Exchange (FIX) Interface

The FIX interface package provides a non-interactive (non GUI) route into the trading system and is primarily designed to service FIX message ‘pipes’. It aggregates services such as order submission, amendment and cancellation.

Fill Interface (FIL)

The FIL interface is another example of non-interactive connections with the system and is supplied to provide a feed of fills out of the system for use by third party back office systems such as Ralph & Nolan. It aggregates services such as fills.

System Monitoring Client (SMC)

The SMC's primary role is to provide an electronic ‘flight-deck’ view of the system components and reporting system performance and faults. Its primary user would be technical support. It aggregates the services provided by the Quality-Of-Service (QOS) package and the statistic services provided by the other domain packages, such as message throughput, idle time, peak load etc.

Object Broadcast Service (OBS)

The OBS handles differing requirements for broadcasting updates of objects (i.e. orders, prices) to a client application.

The first is to broadcast an update (object alteration) to many specific clients, ignoring other logged in clients, such as a change to an order, which should go to very logged in trader in that broadcast group, even if they didn't implicitly request notification for that object.

The second requirement is to broadcast an update (object alteration) to many clients, this time not using a broadcast group but based on the objects the client requested. For example, a price update must go to many clients but only the clients that requested this price (object) and the clients may be in differing broadcast groups.

The OBS is a pool of stateless beans that store these object to application mappings, in effect an application subscribes to an object. When the OBS is informed of an object update, it broadcasts the change to all subscribed applications.

Risk Management System (RMS)

The role of the RMS package is to provide both the pre-trade risk management (order permissioning) and post trade risk monitoring (profit & loss). It provides services that are accessible primarily from the RAC but could also provide services such as profit & loss services to be consumed by the trading application if required.

Order Management System (OMS)

The role of OMS package is to provide the services required for placing, amending, cancelling and querying of orders. In addition to providing these services the OMS also takes care of the in system execution of orders (see the Managing Orders Use-Case) where necessary. It manages orders from many users so is in effect a shared resource, and can be run in parallel.

The OMS can be parallelised because in the majority of cases orders are independent from each other. For example, a trader places a limit order then places a market order, these two orders are independent in how they are run, in other words there is no interaction between these two orders as far as reporting order states, processing fills, etc. is concerned. Because, orders are independent there is no requirement to have all orders for a user or TAG registered in the same OMS. An exception to this rule is where a multiple leg order (for example and OCO or MEL) is entered and in this case all legs of the order must be registered and managed from the same OMS.

The OMS also has the role of managing the triggering of synthetic orders such as the Stop and Market-If-Touched.

Order Book Management System (OBMS)

The OBMS provides services such as order status notification, order status querying, order fill processing, and the provision of segmented views based on individual user/account details of the centralized order book. It also provides a ‘centralised’ account position service.

Applications such as the trading client and risk administration client register interest in receiving information and updates from the OBMS, which responds to input events from the OMSs and fill interfaces. The rationale for dividing order information from the actual order is that some client applications may need to access order information, for example history, current status and fills, but may not be allowed to directly affect the order, for example cancel or amend it. Equally there may be the requirement to allow orders not entered via the system to be represented in the system, for example processing fills and orders entered via a different trading system. In this latter case, there is no concept of the order within our system and it can therefore not exist in the OMS, but we must be able to display the order and maintain its position.

Contract Management System (CMS)

The CMS provides services to locate and download information describing tradable entities. It provides the interfaces to obtain execution point and instrument-specific (commodity and contract) information.

price Subscription Controller (PSC)

The PSC provides a centralized point for access to and a subscription/mechanism for application layer packages to access price information using batching and polling methods. Note the components within the Domain Layer (and certain high performance application layer applications) directly access price information of the ‘PriceBus’ and do not obtain price information from the PSC.

Administration System (AS)

The AS provides the services required for administering the system. For example allowing contracts and user accounts to be configured, order routes to be configured etc.

Data Store (DS)

The DS is responsible for serving the domain and application packages with the data objects within the system such as orders, contract configuration, user accounts, trader accounts etc. It provides a global repository for read and write operations on objects, caching of the objects stored via the persistence package of the infra-structure layer, operates in a lazy read mode, and automatically manages stale data.

All read and write operations on data objects, that must be persisted, go via the DataStore.

Message Routing System (MRS)

The MRS supports the routing of messages between domain layer packages, based on a database of message routing rules. It operates in a stateless manner and coordinates the consumption and delivery of messages to and from the queues, which link the domain packages together. The MRS initially uses MOM queues to communicate between system components but should be treated as a facade allowing a different communication system (TCP/IP, e-mail) to be used as appropriate.

ESA Adapter (ESAA)

The ESA (ESA Adapter) acts as a “bridge” between the EE system and the legacy ESAs. It contains four interfaces these being the orders, fills, prices and configuration data. Additional interfaces may be designed dependant upon specific exchange requirements.

Exchange Gateway (EG)

The EG implements the interface to the exchange-specific gateways. They implement four interfaces, these being a prices interface, an orders interface, a fills interface and a standing/configuration data interface. The internal workings of the EGs are specific to each exchange.

Quality of Service (QoS)

The QoS is responsible for monitoring and gathering the various QoS parameters required from the system. It also provides these parameters via a set of services to the SMC. In addition to his it can be configured to apply a set of rules and if warning or errors are detected and log these via the Log4J package and also if required initiate alerts to administration staff.

Security and License Provider (SLP)

The SLP manages the security logon requests and authentication of users and modules within the system.

Persistence Facade (PF)

The persistence facade provides a coherent interface for persistent storage within the system. It provides storage via JDBC to a third-party RDMS vendor and to disk.

Communications Facade (CF)

The communications facade provides a coherent interface for message queuing and publish-subscribe via JMS to a third party MOM vendor.

Rule Engine (RE)

A third-party rule execution engine is employed within the architecture to provide the user-defined order routing requirements of the MRS. In addition, the rules engine can be employed by the RMS, if required, to provide more complex rule-based order permissioning.

Logging Package (LP)

A third party logging API is used within the system to provide the ability to;
Log messages in a system wide consistent manner.
Support varying formats of log file for example plain text, HTML, XML or binary format messages
Persist messages via JDBC
Send log entries via JavaMail (SMTP, POP3, IMPA, etc)
Manage log entries via JNDI.

This package may require extending to support transactional logging. By utilizing the same logging method across all packages we provide a consistent system wide format of logs.

Service Locator (SL)

This package provides centralized and abstracted access to JNDI services. Multiple clients use the service locator, thus reducing complexity and improving performance by caching previously identified resources.

### SUMMARY

This section has shown how the architecture of this embodiment is divided into distinct logical layers, from the basic system wide functionality in the infrastructure layer through the business logic of the domain layer, to the aggregating of these business services in the application layer then onto the presentation layer. Cross-cutting concerns such as logging, auditing and security have been addressed by providing centralised functionality in the infrastructure layer in the logging package and the security and license provider. Vendor dependencies on RDBMS and MOM have been abstracted and placed in specific components within the system, in the persistence facade and the messaging facade components respectively, therefore reducing the rework required to use other third party applications.

Vendor dependencies due to application server (AS), which generally (although not exclusively) amount to JNDI lookups, have been isolated into the Service Locator package. This Service Locator also acts as a caching interface to JNDI to improve performance.

The responsibility for message flow through the system is decoupled from the components to a discrete messaging subsystem that uses user-defined rules to govern message flow. This provides flexibility in how components can be deployed and the interactions between components.

By providing a broadcast concept into the distribution of prices the embodiment delivers efficient price distribution, both in terms of speed and bandwidth usage. A price concentrator/repeater pair and a price distribution service are capable of batching price updates and delivering them via XML over HTTP. Although multicast does not supply reliable delivery of packets, with the application of the JavaGroups software the system can build up a sequenced and reliable protocol stack if required with no architectural impact.

Having described the context within which the various aspects invention can be implemented in a manner that will be clear to those familiar with the technical field, the specific parts of the system that provide the functionality will now be described in more detail.

Specific Objects in More Detail

The QoS module and those subsystems and modules with which it interacts will now be described in more detail.

The Object Broadcast Service (OBS) is a subsystem that asynchronously sends object updates to the relevant client instances. It is described here because the return route from the domain layer to the application layer for many of the objects (orders, fills, prices, contracts) is through the OBS and its proper operation is therefore critical to the level of service that the system can provide.

FIG. 2 illustrates the main components of the OBS. The OBS is based upon JavaGroups, which is a technology that implements reliable multicast communications between group members based on IP multicast and a configurable protocol stack. The function of JavaGroups will be appreciated by those skilled in the technical field, and this will, therefore, not be described in detail here. Further information, should it be wanted, can be found in JavaGroups User's Guide, Bela Ban, Dept. of Computer Science, Cornell University.

All object updates are notified to an object broadcaster that runs as a Java process outside the application server. The object broadcaster broadcasts onto a JavaGroups channel. Every communications stub (to be described) receives these object updates and filters them to ensure that a client application only receives the relevant updates.

As a client connects to the system, a communications stub is first created on the application layer. This communications stub is assigned a broadcast group based on information relevant to the application and user that connected. This information is retrieved as part of the security checks carried out by the security and license manager. The communications stub then creates a JavaGroups channel and connects onto the object broadcast bus.

Whenever an object is updated, the relevant domain component (OMS, RMS, IMS etc) issues an RMI call to its relevant object broadcaster. The object broadcaster simply broadcasts this object update onto the object broadcast bus. Every communications stub within the application layer will receive the object update. Each stub then filters the object based upon its own internal filter chain to ascertain if it can forward this object update. If a stub is required to forward this update, it when issues an update object call to the communications protocol converter and thence to the client application in the presentation layer. If the object is not to be forwarded the stub simply ignores the object update.

The QoS component (to be described in more detail below) listens to the object broadcast bus and gathers statistics on the number of object broadcasts being generated. It also monitors the broadcast group for communications stubs joining and leaving the bus. Additionally, it monitors for component failures, which is supported by deploying the group membership component within the JavaGroup protocol stack.

The QoS Subsystem

Quality of service monitoring is an integral part of the trading platform. The role of QoS is to monitor the system resource utilization, allow dynamic reconfiguration of components, allow dynamic fault investigation and provide a feed of data in an industry-standard form that can potentially be plugged into existing management consoles. To this end, the use of Java Management Extensions (JMX) has been adopted into the trading system architecture. The QoS management within this architecture is focussed at the business process and application level, rather than at the lower networking level. Software infrastructure and hardware infrastructure management can be embedded into the system through use of third party MBeans if available.

A standard logging package Log4J. managed by the Apache Software Foundation, provides a system-wide standard for logging, extended to support transactional logging. For example, the system can start a transaction to log messages, errors and other events. It then can either commit the changes, whereupon they will be forwarded to the log sink, or rollback the log, effectively throwing away all entries logged within the transaction. During a transaction, logging is not committed to disc to improve performance: only upon commit is the log flushed to disk. Auditing works in a similar manner however does not support the transaction control.

FIG. 3 shows the overall design of this component and how it integrates into the rest of the system.

The major point to note is that an MBean (a Java object that represents a manageable resource, such as an application, a service, a component, or a device) is deployed on a per-pool basis to allow the monitoring and management of the entire bean pool. MBeans can also be integrated through a standard MBean server to allow the monitoring and management of applications and of the software infrastructure as well, if required.

The interactions between MBeans and pools will now be described. FIG. 4 shows how upon creation of a pool bean by invoking the method ejbCreate ( ), the relevant MBean is located by the ServiceLocator. The pool bean (most typically a stateless session bean) then registers itself with its manager bean (MBean). The MBean updates it internal statistics, for example, how many beans are currently in the pool, rate of creation/destruction etc. Then the instance of the bean (EJBObject) is stored in the local cache of the MBean. The MBean then issues an update signal via the MBean Server so to inform any QoS user interface of the latest state of the pool.

As the QoS user interface issues management functions, these are relayed via the MBean Server to the relevant MBean. The MBean then issues multiple method calls to all of the beans within a pool by referencing its internal cache of EJBObjects. Likewise, as each bean issues a notification by invoking the update ( . . . ) method, the MBean processes these multiple calls and then makes an update ( . . . ) method call containing the relevant data as required.

When the container removes the bean from the pool using the method ejbRemove ( ), the bean must call the deRegister ( . . . ) method to inform the MBean to remove its reference from its local store and also issue a new update ( . . . ) message to the MBean server.

The above describes the basic architecture of the manner in which JMX is enabled within the system. Attention now turns to the method of alarm generation, alarm management and remote notification.

Within the MBean specification are specific beans that implement counter and gauge functionality. These are initially employed to produce the required trigger events. Timer beans are used to trigger statistical update events based on a predefined time period. The QoS Management application is configured to receive these notifications and to act as a central repository of messages. These events are transported to the QoS management application through an RMI connector, which itself is implemented as an MBean, allowing it to be dynamically loaded/unloaded as required.

The QoS manager can also access the rules engine (if required) through the rule engine bean. This allowing the implementation of specific customer rules with no change to the application. The JavaMail API is used to support SMTP and POP email communication. This allows the management application to issue alerts and reports to maintenance personnel, who may be remote from the site at which the system is installed.

In more advanced embodiments of the invention, the QoS manager may be extended to actively manage the system. For example, the QoS manager may change bean configuration parameters, and alter application server or message queuing parameters during while the system is running.

Centralised logging is also integrated into the system through the use of Log4J and using the JMX support that Log4J provides. This allows the system to alter logging levels and parameters dynamically during run-time. It also supports the automatic notification of alarm conditions directly to the QoS manager without the need to scan log files on disc. The actual method of logging to disc is by the Log4J SocketAppender and SimpleSocketServer. This allows multiple writers to asynchronously write to the same log file. By decoupling the write/store process through a network connection, the actual process of writing to disc may be offloaded onto another machine. This approach may also be used to producing the audit file.

The parameters that the QoS subsystem monitors and logs will now be described.

The QoS subsystem can be considered as operating at several levels within the system. In this embodiment, the levels are defined as follows:
level 1—hardware and infrastructure monitoring;
level 2—software infrastructure monitoring;
level 3—application monitoring; and
level 4—business process monitoring.

Monitoring at the lowest level, level 1, enables hardware faults to be identified and load to be measured. Level 2 monitoring enables faults in software infrastructure components, such as databases and message oriented middleware faults to be identified. It also allows load within the software infrastructure to be measured. At level 3, monitoring enables end-to-end monitoring of an application. This monitoring is business process agnostic and provides measures on how well an application is performing regardless of its business use. The highest level, Level 4, is concerned with monitoring how well a business process is functioning.

For example, assume that users experience order processing (a business process) is running slowly. Without the ability to drill down to the application layer, this information is of little use. However, if monitoring at level 3 reveals that the order management system is performing slowly, a technician can further drill down through level 2 to discover, for example, that the database writes-per-second rate is low. This might lead on to investigation at level 1 which might, for example, reveal that the discs are full. Although this is a trivial example it demonstrates the need to be able to navigate down through the layers of a system. Monitoring at level 1 is a common and well-understood system implementation task and will not, therefore, be described further. The QoS management component is designed to address the needs of levels 2, 3 and 4.

Equally, active management of the QoS that a system offers requires the performance of three separate tasks, these being:
measurement of the system state at all the levels discussed previously;
decision and prediction based on observed system state; and
management of system configuration to enhance and/or manage system state.

The parameters that are measured by the QoS component of this embodiment are divided into levels as described above. The following table shows examples of the parameters and associated level to be measured. Note this is not an exhaustive list; other embodiments may require monitoring of additional or fewer parameters. Also, Level 2 parameters depend on the particular application server and database server deployed in a particular embodiment.

TABLE 1

| Level | Parameter | |
|---|---|---|
| Level 1 | System dependent therefore not defined here. | |
| Hardware Infrastructure, | | |
| Router, Processor etc. | | |
| Level 2 | Bean Pool Usage, | DB cache usage, |
| Software Infrastructure, | Number of Active | Messages seat by |
| Database server, Message | Beans, | queue per second, |
| Broker, Application | Number of Bean | Messages received |
| Server, Rule Engine etc. | Activations, | by queue per |
| | Number of Bean | second, |
| | Passivations, | Bytes send by |
| | Number of Queued | queue per second, |
| | Jobs, Number of | Bytes received by |
| | Message Sent | queue per second, |
| | per second, | Queue Length, |
| | DB reads per second, | Idle Threads, |
| | DB writes per second, | Memory Usage |
| | DB cache bits per | |
| | second. | |
| | Generic Parameters | Component Specific |
| Level 3 | Number of Jobs | Method specific |
| Component Performance, | processed per second, | parameters such as |
| Order Management System, | Time taken to process | number of |
| Risk Management System, | job, | invocations per |
| Message Routing System | Application Status | second |
| etc. | | |
| Level 4 | Order Round Trip | System Overall |
| Business Process | time, | Performance, |
| performance | Orders Placements | Number of |
| | per second | Concurrent Users, |
| | Order Cancellations | Number of User |
| | per second | Requests per |
| | Order Amendments | second, |
| | per second, | Bandwidth |
| | Price Transit time, | Consumption |
| | Prices Sent per | per User, |
| | second per exchange, | Orders Processed |
| | Login time for Users, | per second per |
| | | Exchange Order |
| | | Processed per |
| | | second per User |

All of the parameters described in Table 1 can be measured on a maximum, minimum and average basis. The system can also alter the sampling rate that at which these measurements are taken. For example, the system allows the above parameters to be measured over a period ranging from 15 seconds to 5 minutes. It may also log a predetermined number (say, ten) best and worst measurements and the time at which they occurred. These measurements may be saved to a permanent store for later analysis. FIG. 5 presents these parameters in diagrammatic form.

Consider the specific example of measurement of timings associated with a message as it is handled by the system.

A message is time stamped (using UTC to millisecond accuracy) at the following points in the system: as it leaves the user interface (A); when it arrives at the server (B); when it leaves the server to the exchange (C); when the exchange responds (D); when it leaves the server for transmission to the user interface (E); and when it arrives at the user interface (F). From these time stamps the following timings can be calculated:

TABLE 2

| | |
|---|---|
| Total Round Trip Time | F − A |
| Total Processing Time | (C − B) + (E − D) |
| Exchange Latency | D − C |
| Network Latency | (B − A) + (F − E) |

FIG. 6 shows how the maximum, minimum and average method invocation times are calculated within the individual bean instances and across the bean pool.

Each bean (A, B and C) within the pool individually counts the number of invocations (per relevant method) and the total time taken within each method. They also keep the maximum and minimum method invocation times. At the end of the sample period they update the respective component manager with the individual counters and reset these counters for the next period. The component manager then aggregates the individual counters to provide pool-based statistics of maximum, minimum and totals. It also calculates the average transaction time within pool by dividing the ‘Total Time Taken by Pool’ by the ‘Total Transaction processed by Pool’ variables (75/7≈10.71 ms in the example shown in FIG. 6).

The parameters are reported as a snapshot every n seconds, where n is the sampling period. The values of the snapshot are based on the aggregated values (as above) of the individual bean values during this n seconds. The sampling period is configurable on a component-by-component basis.

To implement comprehensive QoS management, measurement of operating parameters alone is not sufficient: decisions must be made based upon the parameters measured. Likewise, once parameters have been identified and correlated, and a decision or prediction has been reached, it is advantageous to manage the system actively based on these observations to prevent occurrence of problems occurring. This provides a more reliable system than one that to reacts to problems as they occur. There will now be described details the QoS mechanisms that can be built into a trading system to implement this.

Latency and Accuracy of Data Transmission

This requirement applies to the communication of data from the trading system to external client applications. It is possible to request that the data is sent as fast as possible or that data batching may be applied. It is also possible to request whether all data changes during the period are to be reported or that only the latest data be reported. This communication link support is negotiated during logon to the external application. In effect, a client can connect and request that the system batch data (high latency) but that all changes must be sent, or the client could request that a low-latency link be established and that only the latest data is required. This communication link ‘quality’ depends on the requirements of the external applications and the intermediate communication link (ISDN, 100 Mbit LAN etc.). In response to this request the trading system responds by informing the external application whether it can support the requested link quality or not. It is up to the external application to either renegotiate or accept the systems communication quality offer.

Bandwidth Control

The system can limit the bandwidth available to a user and ensure that the available bandwidth is fairly distributed between clients. There are two aspects to this: firstly to ensure that bandwidth to which a user has access does not exceed a previously defined limit; and secondly to dynamically limit the bandwidth to which a user has access to ensure overall system performance is not degraded. Therefore, the QoS subsystem provides a ‘fair’ allocation of network resources between connected users.

By this mechanism the QoS subsystem can take remedial action to prevent system performance from becoming compromised through excessive loading. For example, if the QoS subsystem determines that the system as a whole is becoming overloaded, it can slow down the rate at which users can enter orders until system load has decreased. Once load has decrease, it can then once again increase the allowed rate of user input.

This is achieved by enabling the system to control bandwidth usage based both on a static configuration per user and also dynamically, as will now be described.

Static Bandwidth Control

Static bandwidth control is implemented by only allowing a user to submit a predetermined number x requests per time unit. The time unit is configurable and is also dynamically updateable. That is to say, the user does not have to log out and then back in for a change in the value x to take effect.

These request limits are organised around the ability to place, amend, cancel or query an order and the total number of request of all types. If a value of zero is specified for any of these parameters then the user has unlimited access to the function controlled by the parameter. An example is set forth in the following tables.

TABLE 3

| Parameter | Value | Effect |
|---|---|---|
| Place Order | 10 | The user can issue up to 10 order placements, |
| | | or order amendment request per second and in |
| Amend Order | 10 | total must not exceed 10 requests per second. |
| | | Because the value query and cancel order are |
| Query Order | 0 | zero the user has unlimited access to these |
| | | requests so can issue more than 10 requests |
| Cancel Order | 0 | per second in total. |
| Total Request | 10 | |
| TimeUnit | 1 | |

TABLE 4

| Parameter | Value | Effect |
|---|---|---|
| Place Order | 10 | The user can issue up to 10 order placements |
| | | and up to one order amendment request per |
| Amend Order | 1 | second, and in total must not exceed 10 |
| | | requests per second. Because the value query |
| Query Order | 0 | and cancel order are zero the user has |
| | | unlimited access to these requests so can issue |
| Cancel Order | 0 | more than 10 request per second in total. |
| Total Request | 10 | |
| TimeUnit | 1 | |

TABLE 5

| Parameter | Value | Effect |
|---|---|---|
| Place Order | 0 | The user can issue unlimited request to place, |
| | | amend, query and cancel orders. |
| Amend Order | 0 | |
| Query Order | 0 | |
| Cancel Order | 0 | |
| Total Request | 0 | |
| TimeUnit | 0 | |

TABLE 6

| Parameter | Value | Effect |
|---|---|---|
| Place Order | 10 | The user can issue up to 10 order placement |
| | | or order cancellations, and up to five order |
| Amend Order | 5 | amendments or order status queries in any |
| | | five-second period. The user may not exceed |
| Query Order | 5 | ten requests in total in any five-second period. |
| Cancel Order | 10 | |
| Total Request | 10 | |
| TimeUnit | 5 | |

The time period of this requirement is treated as a rolling window and not as an absolute time period. This requirement is conveniently implemented as a modified ‘token bucket’ (TB) algorithm as detailed below. The general process is illustrated in FIG. 7.

The request-specific tokens (Place, Amend, Query and Cancel) are generated at rate r which is TimeUnit/RequestSpecificRate. In other words the system generates four token specific rates:
r_{place}=TimeUnit/PlaceOrderRate
r_{amend}=TimeUnit/AmendOrderRate
r_{query}=TimeUnit/QueryOrderRate
r_{cancel}—TimeUnit/CancelOrderRate

The tokens are placed into the relevant request-specific bucket. Additionally the ‘total request’ tokens are generated at rate
rₜₒₜₐₗ=TimeUnit/TotalRequest
and placed into the ‘total rate’ token bucket. Tokens are placed into the buckets until the request rate (PlaceOrderRate, AmendOrderRate etc) is met, at which time additional tokens are ignored. This is termed the ‘depth’. Therefore only a maximum of ‘rate’ tokens may be in a bucket at any point in time.

Note that by setting TimeUnit to zero this disables token creation and therefore completely blocks submission of requests. Request type rates (for example, CancelOrderRate) that are set at zero however are still processed correctly.

Upon receipt of a request the bandwidth control algorithm first determines if the specific request rate (PlaceOrderRate, AmendOrderRate etc.) is zero. If it is, the request is immediately forwarded. Otherwise, the request is forwarded to the request-specific bucket.

If a token for this request is available in the request-specific token bucket a token is removed and the request is forwarded to the total requests token bucket. Otherwise, the request is denied.

The total requests token bucket acts in a similar fashion. Upon receipt of a request, an attempt is make to remove a token from the bucket regardless of the request type. If a token can be removed then the request is forwarded, otherwise the request is denied.

This static choking mechanism is implemented at the extremities of the system: in the trading client and in the inbound FIX gateway.

The mechanism by which processing of batches of requests operates will now be described.

Each request within the batch is taken into account and as such consumes one token of the relevant type. If the number of tokens is exceeded, all tokens are replaced into the bucket (to the maximum depth allowed) and the request is rejected as before. For example, assume that the user can place 10 order per second and that they submit a batch of 15 orders. Fifteen tokens would need to be consumed but only ten are available therefore the batch is rejected and the ten consumed tokens are place back into the bucket.

The parameters (OrderTokenRate, TimeUnit etc) are defined at a user group level and not at the individual user level in this embodiment. All users within a group will operate in parallel to each other with respect to the parameter settings. Additionally there is a requirement for a ‘Disabled User’ group to be created. Users in this group have the UnitTime set at zero. Users can be placed in this group to stop them entering requests into the system.

Dynamic Bandwidth Control

Dynamic bandwidth control is implemented using a throttling mechanism. The first place at which dynamic bandwidth control occurs is located at the client-side object interface and the second is implemented in the messaging facade of the infrastructure component. Note this throttling is in addition to the message flow control and queue length controls of the MOM.

This throttling supports dynamic reconfiguration through the QoS management console and, in the case of user input throttling, through the systems administration component during user set-up to define a default bandwidth quota. Equally, a mechanism to dynamically control user input throttling is provided.

The message facade bandwidth control will be automatically controlled by the system. By this arrangement, as system performance limits are reached, the QoS subsystem automatically begins to throttle message throughput to restore system performance.

The Token Bucket Algorithm

As it is central to operation of bandwidth control in this embodiment, operation of the token bucket algorithm will now be described with reference to FIG. 8. Naturally, all of the objects described here are software objects that can be implemented in many ways.

Tokens are placed in a ‘bucket’ at a predetermined rate r (for example, five per second). Tokens accumulate in the bucket to a maximum depth of D. Tokens placed in the bucket once the maximum depth has been reached are discarded.

When messages arrive (Data In), each message takes a token from the bucket and passes through (Data Out). If no token can be taken from the bucket the message must wait until a token is available, or be discarded.

The rate of token addition r controls the average flow rate. The depth of the bucket D controls the maximum size of burst that can be forwarded through.

Priority Traffic Routing

In a communications route that is operating within a bandwidth target certain types of message must be delivered before others. In this embodiment, message routing priority can be altered in dependence upon customer or business requirements. For example, an organisation may configure the system such that trades placed by an internal trader have a higher delivery priority than trades placed through a ‘black box’ trading application. The prioritisation of routing may also be used to ensure that a given SLA is being met by dynamically altering message priority to ensure timely processing through the system. A user may also have a requirement to prioritise certain traffic types (for example order cancellations) over other traffic types (for example order placement).

This delivery prioritisation is applied at both the message and queue level and can be altered dynamically through the QoS management console.

Traffic prioritisation can be divided into the following areas: general message priority (MP) and user group priority (UP).

The MP and UP areas messages are divided into two general categories these being normal priority (NP) and expedited priority (EP). There is also a prioritisation category (PC) on the message type. This provides for all message of a given type to be expedited regardless of whether the message was initiated by a trader within the normal priority group or expedited group. There is also the concept of queue prioritisation (QP). This can be applied to ensure that all messages to Liffe, for example, are processed before messages to any other exchange.

Therefore, the system can prioritise based upon type of message (MP), user the message originated from (UP) and also override the priority if required using the prioritisation category (PC). The examples presented in the following tables will make this clearer.

The example of Table 7 shows how cancellations are always sent before any other message within user group, and messages from users within group B are always sent before messages form users in groups A. To arrive at the priority, add the relevant MP+UP+PC together to a maximum number of 9.

TABLE 7

| Message Type | MP | PC |
|---|---|---|
| Add | NP | NP |
| Cancel | EP | NP |
| Amend | NP | NP |
| Query | NP | NP |

| User | UP |
|---|---|
| A | NP |
| B | EP |

| | NP | EP |
|---|---|---|
| MP | 1 | 2 |
| UP | 1 | 3 |
| PC | 1 | 1 |

| | A | B |
|---|---|---|
| Add | 1 + 1 + 1 = 3 | 1 + 3 + 1 = 5 |
| Cancel | 2 + 1 + 1 = 4 | 2 + 3 + 1 = 6 |
| Amend | 1 + 1 + 1 = 3 | 1 + 3 + 1 = 5 |
| Query | 1 + 1 + 1 = 3 | 1 + 3 + 1 = 5 |

The example of Table 8 shows how query requests are always sent before any other message regardless of user, but within user prioritisation, cancellations are sent first and B's messages are always sent before A's messages. Also note that queries from higher priority users are given preference over normal priority users.

TABLE 8

| Message Type | MP | PC |
|---|---|---|
| Add | NP | NP |
| Cancel | EP | NP |
| Amend | NP | NP |
| Query | NP | EP |

| User | UP |
|---|---|
| A | NP |
| B | EP |

| | NP | EP |
|---|---|---|
| GMP | 1 | 2 |
| UMP | 1 | 3 |
| PC | 1 | 5 |

| | A | B |
|---|---|---|
| Add | 1 + 1 + 1 = 3 | 1 + 3 + 1 = 5 |
| Cancel | 2 + 1 + 1 = 4 | 2 + 3 + 1 = 6 |
| Amend | 1 + 1 + 1 = 3 | 1 + 3 + 1 = 5 |
| Query | 1 + 1 + 5 = 7 | 1 + 3 + 5 = 9 |

Dynamic Reconfiguration of System Components

System components of the embodiment are dynamically configurable to remove the need to stop and restart the component. For example, it must be possible to reconfigure a component to enable log file production and then at a later stage disable this log file production, without having to stop and start the component. Also these configuration parameters are centrally stored to ease configuration management and control.

The QoS subsystem built into any one embodiment may not provide all of these complex measurement and decision support functionalities directly. However, it is clearly to be preferred that it provides support for them. Moreover, it is preferred that the QoS systems are designed in a way to allow integration into existing management facilities that a user may possess.

The Embodiment as a Component of a Network

With reference first to FIG. 9, a typical electronic market can be represented as several computers connected in a network in a client/server arrangement.

The organisation running the market provides a server computer 10, and it is this server that implements the invention. This is connected over a network 12 to multiple client computers 14, each constituting a client terminal. The network can include many diverse components, some local-area and some wide- well area, as required by the geographical distribution of the clients, and may, for example, include local-area Ethernet, long-distance leased lines and the Internet

In a typical case, the server is a high-powered computer or cluster of computers capable of handling substantially simultaneous requests from many clients. Each client terminal is typically a considerably smaller computer, such as a single-user workstation. For the purposes of this illustrative embodiment, each client terminal is a personal computer having a Java virtual machine running under the Microsoft Windows XP operating system.

When a client 14 connects to the server 10, it is delivered over the network 12 a stream of data that represents the instantaneous state of the market. This data includes a description of all outstanding bids and asks, and of any trading activity within the market. The client 14 includes a user interface that has a graphical display. The content of the graphical display is updated, in as near as possible real-time, to reflect the instantaneous state of the market in a graphical form. The client 14 can also send a request over the network 12 to the server 10 to initiate a trading action. Typically, each client may be able to connect to several hosts to enable it to trade in several markets. The QoS subsystem ensures that data is transmitted to and orders are received from the clients in a timely manner.

The above description is a simplification of an actual implementation of an electronic trading system. However, in addition to the embodiment of the invention, the components described are entirely familiar to those skilled in the technical field, as will the details of how they might be implemented in practice, so they will not be described here further.

Each client 14 executes a software program that allows a user to interact with the server 10 by creating a display that represents data received from the server 10 and sending requests to the server 10 in response to a user's input. In this embodiment, the software program is a Java program (or a component of a Java program) that executes within the virtual machine. The data received from the server includes at least a list of prices and the number of bids or asks at each of the prices. Implementation of the embodiment as a software component or a computer software product can be carried out in many alternative ways, as best suited to a particular application, using methodologies and techniques were unknown to those skilled in the technical field.

JAVA, JMX and JAVABEANS are registered trade marks of Sun Microsystems, Inc.

What is claimed is:

1. An electronic trading system comprising a multi-level quality-of-service (QoS) subsystem, which subsystem is operative to impose limitations upon the initiation of electronic trading activities in order that the performance of a component of the system or of the system as a whole is maintained within specified tolerances.

2. A trading system according to claim 1 in which the QoS subsystem imposes a limit upon the rate at which data can enter the system.

3. A trading system according to claim 2 in which the QoS subsystem limits the number of requests that will be accepted on an input.

4. A trading system according to claim 3 in which the QoS subsystem controls the number of requests that can be made in a time slice.

5. A trading system according to claim 1 which the QoS subsystem imposes a limit on the size of burst data that may be received into the system in a time slice.

6. A trading system according to claim 1 in which the token bucket algorithm is used in order to limit the flow of requests into the system.

7. A trading system according to claim 6 in which the time slice is a sliding time slice.

8. A trading system according to claim 1 in which the QoS subsystem operates such that the system provides a level of service that is dependent upon the identity of a user from which the service originates or to whom it is directed.

9. A trading system according to claim 1 in which the QoS subsystem operates such that the system provides a level of service that is dependent upon the nature of a service that is requested.

10. A trading system according to claim 1 in which the QoS subsystem is operative to measure its performance and dynamically reconfigure operation of the system based on these measurements to ensure a defined level of quality of service.

11. A trading system according to claim 1 in which the QoS subsystem is operative to increase restrictions on users' access to the system as its load exceeds a predefined limit.

12. A trading system according to claim 1 in which the QoS subsystem is operative to assign a priority to a message, messages with a high priority being handled in preference to those with a low priority.

13. A trading system according to claim 12 in which the priority is determined in accordance with one or more of the sender of the message, the recipient of the message or the content of the message.

14. A trading system according to claim 12 in which the priority is a numerical value that is calculated by addition of contributed values derived from one or more of the sender of the message, the recipient of the message or the content of the message.

15. A trading system according to claim 1 in which the QoS subsystem is operative to control latency and accuracy of communication of data from the trading system to external client applications.

16. A trading system according to claim 15 in which the client application may request that the data is sent as fast as possible or that data batching may be applied.

17. A trading system according to claim 15 in which the client application may request that all data changes during a period are to be reported or that only the latest data be reported.

18. A trading system according to claim 1 in which the QoS subsystem monitors performance of the application by way of Java management extensions.

19. A trading system according to claim 1 that utilises a rule-based system to control alarm reporting, fault diagnosis and reconfiguration.

20. A computer software product executable upon a computer hardware platform to perform as an electronic trading system comprising a multi-level quality-of-service (QoS) subsystem, which subsystem is operative to impose limitations upon the initiation of electronic trading activities in order that the performance of a component of the system or of the system as a whole is maintained within specified tolerances.

21. A server in a network of trading computers comprising a computer hardware platform executing a computer software product to perform as an electronic trading system comprising a multi-level quality-of-service (QoS) subsystem, which subsystem is operative to impose limitations upon the initiation of electronic trading activities in order that the performance of a component of the system or of the system as a whole is maintained within specified tolerances.

22. A method of operating an electronic trading system that comprises a quality-of-service (QoS) subsystem, which subsystem imposes limitations upon initiation of trading activities in order that the performance of a component of the system or of the system as a whole is maintained within specified tolerances.

23. A method according to claim 22 in which the QoS subsystem imposes a limit upon the rate at which data can enter the system.

24. A method according to claim 23 in which the QoS subsystem limits the number of requests that will be accepted on an input.

25. A method according to claim 24 in which the QoS subsystem controls the number of requests that can be made in a time slice.

26. A method according to claim 22 in which the QoS subsystem imposes a limit on the size of burst data that may be received into the system in a time slice.

27. A method according to claim 22 in which the token bucket algorithm operates to limit the flow of requests into the system.

28. A method according to claim 27 in which the time slice is a sliding time slice.

29. A method according to claim 22 which the QoS subsystem operates such that the system provides a level of service that is dependent upon the identity of a user from which the service originates or to whom it is directed.

30. A method according to claim 22 in which the QoS subsystem operates such that the system provides a level of service that is dependent upon the nature of a service that is requested.

31. A method according to claim 22 in which the QoS subsystem operates to measure its performance and dynamically reconfigure operation of the system based on these measurements to ensure a defined level of quality-of service.

32. A method according to claim 22 in which the QoS subsystem operates to increase restrictions on users' access to the system as its load exceeds a predefined limit.

33. A method according to claim 22 in which the QoS subsystem operates to assign a priority to a message, messages with a high priority being handled in preference to those with a low priority.

34. A method according to claim 33 in which the priority is determined in accordance with one or more of the sender of the message, the recipient of the message or the content of the message.

35. A method according to claim 33 in which the priority is a numerical value that is calculated by addition of contributed values derived from one or more of the sender of the message, the recipient of the message or the content of the message.

36. A method according claim 22 in which the QoS subsystem control latency and accuracy of communication of data from the trading system to external client applications.

37. A method according to claim 36 in which the client application may request that the data is sent as fast as possible or that data batching may be applied.

38. A method according to claim 36 in which the client application may request that all data changes during a period are to be reported or that only the latest data be reported.

39. A method according to claim 22 in which the QoS subsystem monitors performance of the application by way of Java management extensions.

40. A method according to claim 22 that utilises a rule-based system to control alarm reporting, fault diagnosis and reconfiguration.
